(19) United States
(12) Patent Application Publication
(10) Pub. No.: US 2010/0020634 A1
(43) Pub. Date: Jan. 28, 2010

(54) Methods and apparatus for the preparation of dehydrated drinking products

(76) Inventors: Joseph V. Kosmoski, Wildomar, CA (US); Boris Dushine, New York, NY (US)

Correspondence Address: Joseph V. Kosmoski, 33880 Harvest Way East, Wildomar, CA, 92595, US

(21) Appl. No.: 12/459,743

(22) Filed: Jul. 6, 2009

Related U.S. Application Data
(63) Continuation-in-part of application No. 11/210,716, filed on Aug. 24, 2005, now abandoned.
(60) Provisional application No. 60/604,442, filed on Aug. 25, 2004.

(51) Int. Cl. B01F 13/08

(52) U.S. Cl. 366/273

(57) ABSTRACT

The present invention is directed to apparatus and methods for the reconstitution of dehydrated drinking products. More specifically, a dehydrated drinking product preparation devise is described as a fully integrated system comprising a magnetic mixer, vessel, stir bar and cap. Furthermore, methods for preparing dehydrated drinking products for human consumption are described using the devise.

### CROSS REFERENCE TO RELATED APPLICATION

This application is a continuation-in-part of Application Ser. No. 11/210,716 filed Aug. 24, 2005, which claims benefit of Provisional Application No. 60/604,442 filed on Aug. 25, 2004, incorporated herein by reference in its entirety.

### FIELD OF THE INVENTION

The invention relates generally to the field of home consumer products. More specifically, the invention relates to an integrated dehydrated drinking product preparation apparatus and methods for preparing dehydrated drinking products for human consumption.

### BACKGROUND OF THE INVENTION

There are many dehydrated drinking products available in the marketplace today. These products generate billions of dollars annually. Despite the prevalence of dehydrated drinking products, there are few home consumer devices or methods for the automated preparation of dehydrated drinking products for human consumption.

Great effort has been directed towards the formulation of dehydrated drinking products to facilitate their reconstitution. In many cases, certain ingredients, such as hydrophobic proteins and lipids have been eliminated due to the difficulty to manually prepare drinks with these low solubility components. Sometimes removing these ingredients can reduce the nutritional value of the drinking product. Hence there is a need from both the consumer and producers of dehydrated drinking products for products and methods that can effectively reconstitute dehydrated drinking products for human consumption.

Scientists in academic and industrial laboratories have used magnetic stir plates for decades to prepare solutions. These mixers have proven useful. However, they are inappropriate for home consumers due to cost, design and utility. Significant and novel modifications are needed to adapt this technology for the home consumer. Hence, laboratory mixers are not marketed beyond their original laboratory settings.

Blenders have made their way into the average household. These devises use strong mechanical shearing forces to blend ingredients. The destructive action of blenders can introduce air into the mixture and accelerate oxidation and denaturation. Magnetic mixers differ in that they are non-destructive. Hence, blenders are quite different and inappropriate for preparing most dehydrated drinking products.

Thus, a need exists for novel household products and methods that are specifically designed to reconstitute dehydrated drinking products for human consumption.

### SUMMARY OF THE INVENTION

An object of the present invention is a fully integrated dehydrated drinking product preparation apparatus. More specifically, the integrated apparatus comprises of a magnetic stir plate, vessel, stir bar and cap components. Through empirical testing, optimized novel specifications have been identified for each component. The described adaptations allow each component to work synergistically with each other as an integrated system and optimize mixing of dehydrated drinking products.

A further object of the present invention is a fully integrated dehydrated drinking product preparation apparatus adapted for use in a domestic setting. Magnetic mixing technology for laboratory use lacks component integration and individual components are sold separately. Furthermore, the materials and design of current laboratory magnetic stir plates are impractical for domestic use. Hence, numerous adaptations to the individual components have resulted in domestic optimization of a fully integrated dehydrated drinking product preparation apparatus.

A further object of the invention is to provide an integrated magnetic stir plate adapted to prepare dehydrated drinking products for human consumption in a domestic setting. More specifically, the stir plate has been modified to optimally align the vessel and stir bar with the coupling magnets of the stir plate through the use of a novel positioning element. Furthermore, the stir plate has been modified with a sensor guided linear speed control interface capable of maintaining speeds ranging from zero to as much as 1600 revolutions per minute (rpms). In addition, the stir plate has been modified from AC to DC power and fitted with DC electronic components. Finally, parts and materials were carefully chosen to reduce the cost by an order of magnitude, thus making the product reasonably affordable to a home consumer market audience.

A further object of the invention is to provide an integrated vessel adapted to function as a mixing vessel, storage vessel, serving vessel and drinking vessel. More specifically, the vessel has been adapted to optimize preparation and consumption of about 4 liquid ounces up to about 32 liquid ounces. Furthermore, novel specifications are described to accommodate the stir bar and it's handling during pouring or drinking the liquid contents. Finally, empirical testing results define specifications and limitations of vessel dimensions, which optimize mixing dynamics.

Another object of the invention is to provide an integrated cap adapted for storage and consumption of the final drinking product. Furthermore, the cap has been modified to prevent the exit of the stir bar while still allowing facile pouring or consumption of the final drinking product.

A further object of the invention is to provide an integrated optimized stir bar, that optimizes mixing performance. More specifically, dimensions are described that optimize magnetic coupling with the stir plate's coupling magnets. In addition, the dimensions described allow the stir bar to function properly with other adaptations of the vessel and the cap.

It is a further object of the present invention to provide methods for the reconstitution of dehydrated drinking products into liquids for human consumption. Accordingly, one object of the present invention is to provide methods for introducing dehydrated drinking products to a dynamic mixing system. Another object of the invention is to provide methods for limiting the introduction of air into the mixing system. Still, another object of the invention is to provide methods to prevent the stir bar from exiting the vessel while pouring or consuming the reconstituted drinking product.

These and other objects and features of the invention will become more fully apparent when the following detailed description is read in conjunction with the accompanying examples. However, it is to be understood that both the foregoing summary of the invention and the following detailed description are of a preferred embodiment, and not restrictive of the invention or other alternative embodiments of the invention.

### DETAILED DESCRIPTION OF THE INVENTION

Definitions Within the practice of the present invention “magnetic stir plate” refers to any mechanical motorized device that can drive a stir bar for the purpose of mixing or reconstitution. Virtually any modification of magnetic stir plate is contemplated by this invention.

Within the practice of the present invention “reconstitution” refers to combining and mixing a dehydrated drinking product with a liquid in order to prepare a drinking product for human consumption. Virtually any modification of reconstitution is contemplated by this invention.

Within the practice of the present invention “linear speed control interface” refers to any device or system that allows a user to adjust the mixing speed of magnetic stir plate wherein the adjustment of the interface and the mixing speed of the magnetic stir plate are proportionate and approximately linear. Virtually any modification of linear speed control interface is contemplated by this invention.

Within the practice of the present invention “coupling magnets” refers to one or more magnets within the magnetic stir plate that couples with the magnetic field of the stir bar. Virtually any modification of coupling magnets is contemplated by this invention.

Within the practice of the present invention “coupling” refers to a magnetic force between two or more coupling magnets that align and hold the stir bar relative to each other. Virtually any modification of coupling is contemplated by this invention.

Within the practice of the present invention “decoupling” refers to breaking a magnetic force between two or more coupling magnets and the stir bar. Virtually any modification of decoupling is contemplated by this invention.

Within the practice of the present invention “multi-prong stir bar retention feature” refers to two or more tabs projecting from the drinking port which blocks the exit of a stir bar from the drinking port without significantly inhibiting the flow of liquid from the drinking port. Virtually any modification of multi-prong stir bar retention feature is contemplated by this invention.

Within the practice of the present invention “integrated speed sensing system” refers to any group of parts within the stir plate which can directly or indirectly measure, report or record the rotational speed of the motor, coupling magnets or stir bar. Virtually any modification of integrated speed sensing system is contemplated by this invention.

Within the practice of the present invention “Hall sensor” refers to any device that can detect magnetic fields. Virtually any modification of Hall sensor is contemplated by this invention.

Within the practice of the present invention “integrated speed maintaining system” refers to any group of parts within the stir plate which can directly or indirectly maintain the rotational speed of the motor, coupling magnets or stir bar about constant. Virtually any modification of integrated speed maintaining system is contemplated by this invention.

Within the practice of the present invention “integrated decoupling sensing system” refers to any group of parts within the stir plate that can directly or indirectly detect the decoupling of the coupling magnets from the stir bar. Virtually any modification of integrated decoupling sensing system is contemplated by this invention.

Within the practice of the present invention “integrated decoupling recovery system” refers to any group of parts within the stir plate, which can directly or indirectly take action to recouple the coupling magnets and stir bar the after decoupling. Virtually any modification of integrated decoupling recovery system is contemplated by this invention.

Within the practice of the present invention “vessel” refers to any container used for mixing, storing, serving or consuming dehydrated drinking products. Virtually any modification of vessel is contemplated by this invention.

Within the practice of the present invention “positioning element” refers to three or more raised features on the outer edge of the stir plate housing that optimally aligns the vessel, stir plate, coupling magnets and stir bar. Virtually any modification of positioning element is contemplated by this invention.

Within the practice of the present invention “optimized integrated stir bar” refers to a specific size and shape of stir bar that has optimized magnetic field overlap with the coupling magnets and fit the requirements to function with the vessel and cap. Virtually any modification of optimized integrated stir bar is contemplated by this invention.

Within the practice of the present invention “automatic time out feature” refers any component or system that stops the mixing process after a specified amount of time. Virtually any modification of automatic time out feature is contemplated by this invention.

Invention Overview

In an original embodiment, an alpha prototype kit was made using off the shelf components. More specifically, a kit was made comprising of: a Coming stir plate model # PC-353, a 1½″ cylindrical stir bar and a Rubbermaid vessel with cap. Although the combination of these components was novel and the kit was successful in preparing numerous dehydrated drinking products, the system lacked optimization and practicality as a real market product.

In a preferred embodiment, an integrated dehydrated drinking product preparation apparatus was constructed, comprising of a novel magnetic stir plate, vessel, stir bar and cap. The integrated apparatus was a significant improvement from the original alpha prototype. More specifically, novel design specifications were invented for each component to improve the synergy between the components, and optimized the system for preparing dehydrated drinking products intended for human consumption. Below we describe each component and their novel improvements leading to the invention of a novel integrated dehydrated drinking product preparation apparatus.

In one embodiment, the stir plate is modified with a positioning element, which aligns the vessel on the stir plate. Original positioning element designs utilized an indentation that was an exact and complete footprint of the vessel. However, this strategy was not optimal for a home consumer product because it could trap spilled liquids and was difficult to clean. In our preferred embodiment, the positioning element design was revised to include four raised edges on the mixer's housing centered every 90 degree along the outer circumference of the mixer. This noncontiguous edge creates a footprint for the vessel to fit into. Any liquid that would spill onto the surface of the stir plate could drain from the positioning element. In the preferred embodiment the positioning element helps integrate the vessel, stir plate and stir bar by aligning the underlying coupling magnets of the magnetic stir plate with the center of the vessel, thereby aligning the optimized integrated stir bar in the center of the vessel to provide silent and efficient mixing.

In another embodiment, the stir plate is modified with a linear speed control interface. The interface allows the user to adjust the mixing speed of the integrated apparatus. As the interface is adjusted the speed of the mixing apparatus is also adjusted proportionately and linearly.

In one embodiment, the linear speed control interface consists of a linear speed control knob, or knob, attached to a potentiometer. The potentiometer has 270 degrees of rotation and can adjust the speed of the motor proportionately and linearly. At the “zero degree point” the speed is zero rpm. When the potentiometer is adjusted to the one-quarter position of about 67.5 degrees, the speed is about 300 rpm. When the potentiometer is adjusted to the midpoint at 135 degrees rotation, the speed is about 600 rpm. When the potentiometer is adjusted to the three-quarter position of about 202.5 degrees, the speed is about 900 rpm. Finally, when the potentiometer is adjusted to the full on position of about 270 degrees, the speed is about 1200 rpm. The potentiometer is capable of any degree of rotation from zero to 270 degrees, thereby allowing any corresponding speed of the mixing apparatus. For example in the aforementioned example where the max speed is about 1200 rpm, if the linear speed control interface is adjusted to about 250 degrees of rotation, which is about 92.3% of the allowed rotation, the speed of the apparatus is about 1111 rpm, which is about 92.3% of the allowed maximum speed. Several other embodiments tested different maximum speeds of the apparatus, using the same linear speed control interface described above. For example, with a maximum speed of 1600, the quarter, half and three quarter rotation of the potentiometer corresponded to 400, 800 and 1200 rpms respectively. Maximum speed of 800, 1000, 1200, 1600 and 2000 were all tested and showed utility in preparing dehydrated drinking products. By preprogramming the microcontroller, maximum mixing speeds can be assigned to optimize a specific mixing application, thereby creating mixing products and methods for different markets.

In the preferred embodiment, the linear speed control interface consisted of a control knob attached to a potentiometer with 270 degrees of rotational adjustment. The speed range of the apparatus was from zero rpm to as much as 1200 rpm. Any speed between zero and 1200 rpm was attainable through adjustment of the linear speed control interface.

In another embodiment, coupling magnet configurations were tested and optimized for integration with a specific stir bar. More specifically, coupling magnets were optimized for optimal field overlap and orientation with an optimized integrated stir bar measuring about 2 inches long, and ⅜ inch wide. This is a novel integration feature since laboratory stir plate are designed to function with a wide array of different size stir bars, and not optimized for any one specific stir bar.

In the preferred embodiment, two coupling magnets were mounted on an iron bar such that their position, orientation and magnetic field were optimized to couple with a roughly cylindrical shaped stir bar of about 2 inches in length and about ⅜ inch in diameter.

The preferred embodiment also utilized direct current (DC) electronic systems. Thus, the stir plate was fitted with a DC power jack capable of receiving power from a low voltage DC power source. In the preferred embodiment, alternating current (AC) power was transformed to DC power from a wall-mounted transformer. In this embodiment, no AC power reached the stir plate itself, thereby reducing the possibility and severity of electrical shock.

In another embodiment, the magnetic stir plate could be powered from an appropriate battery source. The dehydrated drinking product preparation apparatus was fitted with a battery pack that provided DC power through the power jack.

Accordingly, DC electronics allowed integration of several novel systems to improve current stir plate functions. Namely a microcontroller, sensors, integrated speed sensing system, integrated speed maintaining system, integrated decoupling sensing systems and an integrated decoupling recovery system were created to address and eliminate problems associated with traditional laboratory mixers.

In the preferred embodiment, a microcontroller was integrated into the stir plate. The microcontroller may accept data input from the linear speed control interface, sensors, and motor. Data is processed and by the microcontroller and the appropriate action is taken according to the programmed commands. The preprogrammed microcontroller controls the action of the motor, integrated speed maintaining system, integrated decoupling recovery system, and LED lamp.

In another embodiment, sensors are integrated into the electronics system to provide data about the current function of the stir plate. More specifically, optical and magnetic Hall sensors are implemented to observe and report the rpms of the coupling magnets and motor. In the preferred embodiment a magnetically triggered Hall sensor is mounted proximal to the coupling magnets such that rpms of the coupling magnets and motor are observed and reported to the microcontroller. The data from the Hall sensor is processed by the microcontroller, which can affect the function of the motor, integrated speed maintaining system, integrated decoupling recovery system, and LED lamp according to the program commands.

It was observed that traditional laboratory stir plates failed to maintain a constant speed upon addition of dehydrated drinking products to the liquid in the vessel. The observed reduction in speed was due to increased load on the mechanical systems, namely the stir bar and motor, due to the increase in viscosity as the dehydrated drinking product dissolved. Even though electrical current remained constant, the rpms of the stir plate would decrease, thereby adversely affecting the vortex and mixing efficiency. In addition, upon decoupling it was also observed that the speed of the laboratory stir plates would increase due to decrease load on the mechanical system. Lifting and removing the vessel from an actively mixing apparatus simulates decoupling and would also give rise to increased motor speed. In some laboratory models, the speed could increase dramatically, depending on the load due to viscosity and the torque of the motor.

In the preferred embodiment, the motor speed remains constant even though there may be increased or decreased load on the mechanical systems of the stir plate. This is achieved through the action of the integrated speed maintaining system. More specifically, the constant monitoring of the speed from the integrated speed sensing system provides data for the microcontroller about the speed of the coupling magnets and motor, and constantly makes adjustments to the electrical current driving to the motor. Upon change in load to the mechanical system, the speed is “recovered” within a few seconds. Although the electrical current sent to the motor may change, the speed of the stir plate remains relatively constant.

In yet another embodiment, an integrated decoupling sensing system is used to detect decoupling of the coupling magnets with the stir bar. Decoupling is a serious problem with most laboratory systems and many factors can contribute to decoupling. There are several modifications made to the integrated system to reduce decoupling that will be discussed later in the specification. However, in the unlikely event that decoupling does occur, it needs to be detected and corrected.

In a preferred embodiment, an integrated decoupling sensing system is used to detect decoupling of the coupling magnets and the stir bar. One means of sensing decoupling is to measure and detect load or torque on the motor. A sudden decrease in load or torque is indicative of decoupling. Some motors provide this feedback to the microcontroller and have been tested and confirmed as reliable information. In the preferred embodiment, data from the integrated speed sensing system is combined with data about the electrical current sent to the motor to indirectly calculate load or torque on the motor. In this embodiment, the Hall sensor is an integral component of the integrated speed sensing system and the integrated decoupling sensing system.

In addition to sensing decoupling, novel adaptations have been made to correct decoupling. In the preferred embodiment of the invention, an integrated decoupling recovery system recouples a decoupled stir bar. Upon decoupling, the integrated decoupling sensing system provides data from the Hall sensor to the microcontroller and the integrated decoupling recovery system reduces the motor speed sufficiently to recouple the coupling magnets and stir bar and then the motor speed is returned to an appropriate speed.

In another embodiment the stir plate is fitted with a LED indicator lamp that is visible to the user. In the preferred embodiment, the LED lamp is on when the motor is running with rmps greater than zero and the LED is off when the motor is not running or rpms are zero.

In yet another embodiment, the stir pate's microcontroller is programmed to automatically stop the motor after a set period of time. In the preferred embodiment, the stir plate's microcontroller is programmed to automatically stop the motor of the magnetic stir plate by eliminating the electrical current to the motor after ten minutes from the most recent adjustment of the integrated speed control interface. This adaptation is referred to as the automatic time out feature. Concurrently, the LED lamp flashes on and off to indicate the automatic time out feature has been engaged.

Numerous stir bars are commercially available. Stir bars come in many shapes and sizes. Unlike laboratory stir plates that are designed to function with many different stir bar shapes and sizes with some loss of optimization, the integrated dehydrated drinking product preparation apparatus is designed to function with a specific stir bar shape and size. We refer to a stir bar that is optimized to function with all components of the integrated dehydrated drinking product preparation apparatus as the integrated optimized stir bar. In the preferred embodiment, the integrated optimized stir bar's magnetic field is optimally overlapped with the magnetic field of the coupling magnets. Furthermore the length and width of the integrated optimized stir bar functions with the stir bar capturing features of the lid and vessel. In the preferred embodiment the integrated optimized stir bar measures about 2 inches in length and about ⅜ inch in diameter. The integrated optimized stir bar is also encapsulated with PTFE (polytetrafluoroethylene).

The stir bar dimensions also affect the mixing capacity of the system. In turn, the optimal mixing speed is a function of the shape and size of the stir bar. The integrated optimized stir bar showed excellent mixing with speeds up to 1600 rpm. At speeds greater than 1600 rpm, decoupling and incorporation of air became problematic. The volume and viscosity of liquid within the vessel also affects the optimal speed and stir bar configuration. For the aforementioned integrated optimized stir bar, all speeds from 100 rpm to 1600 rpm using 100 rpm linear increments were tested on volumes of water ranging from 4 liquid ounces to 32 liquid ounces using 1-ounce increments. Mixing was achieved with all combinations of speed and liquid volume. Several other stir bars were tested with less success. It was also observed that in certain cases where the volume of liquid was limited and viscosity was low, that the optimal maximum speed was less than 1600 rpm. Thus, in the preferred embodiment, the optimal mixing speed of the integrated dehydrated drinking product preparation apparatus is from a minimum speed of zero rpm to a maximum speed ranging from 800 rpm to 1600 rpm.

In one embodiment, the vessel is an integrated component of the dehydrated drinking product preparation apparatus. In the preferred embodiment, the vessel is a mixing vessel, storage vessel, serving vessel and drinking vessel. To achieve this utility and smoothly integrate with the other components of the apparatus, the following specifications were incorporated into the vessel design. To begin with, the exterior dimensions of the vessel at the bottom were made to fit closely within the positioning element of the stir plate. Furthermore, the opening at the top was critical to integrate with the cap. More specifically, matching threads to the cap and a leak proof fit were adapted. Furthermore, the diameter of the opening at the top should be greater than the length of the stir bar. In the preferred embodiment, the stir bar measured about 2 inches in length, therefore in the preferred embodiment the opening of the vessel at the top measures greater than 2 inches in diameter. The wide opening also facilitates addition of dehydrated drinking products to the vessel when mixing. Next, the dimensions of the vessel needed to accommodate liquid volumes from 4 liquid ounces to 32 liquid ounces.

In addition, the vessel must allow for some headspace beyond the maximum recommended liquid volume. Furthermore, empirical testing showed that for larger volumes, a ratio of about 2 to 1 was optimal for height and diameter of the vessel respectively. These rough vessel dimensions showed excellent mixing and vortex dynamics.

Of critical importance for a home consumer is the silent operation of the apparatus. It was noted that the stir bar would make noise by contacting with a mixing vessel. Numerous features were tested and it was determined that the interior bottom surface of the vessel required novel adaptations to comply with the silence requirement.

In the preferred embodiment, the interior bottom surface of the vessel must be smooth with a slightly convex curvature.

In another embodiment, the vessel was adapted to capture the stir bar when pouring the liquid contents from the vessel. More specifically, the shape of the vessel near the bottom could be modified to create an impression, which holds the stir bar upon pouring. In the preferred embodiment, the vessel is adapted by increasing the diameter near the bottom relative to the diameter slightly above, thereby creating a cross sectional curvature that captures the stir bar upon pouring the liquid contents.

In another embodiment, the vessel was modified with marked graduations to measure the liquid volume within the vessel.

In one embodiment, the cap is adapted to integrate with the vessel and function with the stir bar. In the preferred embodiment, a cap is integrated with the vessel to make a leak proof seal with the opening of the vessel. Furthermore, the cap is fitted with a drinking access port. The drinking access port is fitted with a cap with it's own leak proof seal. In addition, the drinking port is modified to prevent the stir bar from exiting through the opening of the drinking port. More specifically, in the preferred embodiment the drinking port is modified with a multi-pronged stir bar retention feature comprising of four tabs projecting from the edges of the port towards the center of the drinking port. In the preferred embodiment, the width of the stir bar is about ⅜ inch and therefore the opening of the drinking port is divided into several contiguous areas with diameters less than ⅜ inch.

A prototype was constructed with all of the aforementioned preferred embodiments and tested extensively. The preferred embodiment prototype, hereby referred to as the omega prototype, was used to prepare numerous dehydrated drinking products including: baby formula, dietary supplements, protein and amino acid based drinks, weight gainer drinks, sugar based drinks such as lemonade and Kool Aid ™, chocolate milk from both powder and syrup, electrolyte drinks, fiber drinks, orange juice from concentrate and many more dehydrated drinking products. In ever case, the integrated dehydrated drinking product preparation apparatus was successful in reconstituting the drinks in volumes between 4 and 32 liquid ounces. Upon consumption, it was noticed that the resultant dehydrated drinking product were more homogeneous and in some cases tasted better.

In another embodiment different program code was downloaded to the microcontroller of the omega prototypes. By installing different programming code, the same hardware of the integrated dehydrated drinking product preparation apparatus could be optimized for a specific application and niche market. More specifically, downloading specific program code while conserving the remaining component specifications of the apparatus could create many mixing products optimized for a specific niche market.

In one preferred embodiment, the program code was optimized for preparing baby formula. More specifically, the maximum speed attained through the linear speed interface was limited to 800 rpms. Through empirical testing, 800 rpms was the maximum speed necessary to prepare 32 liquid ounces of baby formula and still prevent over mixing through the introduction of air.

In another preferred embodiment, the program code was optimized for preparing dietary supplement protein drinks. More specifically, due to the increased viscosity of the dietary supplement protein drink the maximum speed was increased to 1600 rpm. Through empirical testing, 1600 rpms was the maximum speed necessary to prepare 32 liquid ounces of dietary supplement protein drink and still prevent over mixing through the introduction of air.

In another embodiment, the rate of acceleration of the stir plate was limited to prevent decoupling. More specifically, the strength of the torque force felt on stir bar due to motor acceleration and solution viscosity was limited to less than the strength of the coupling force between the coupling magnets and stir bar. In the preferred embodiment, programming code was developed to limit the strength of the torque force felt on stir bar due to motor acceleration and solution viscosity to less than the strength of the coupling force between the coupling magnets and stir bar.

In the following embodiments, methods were tested and optimized. More specifically, the order of addition and mixing was optimized. In the preferred embodiment, the liquid is added first, Then the stir bar was added, then the mixer speed is adjusted to make a vortex, and finally the dehydrated drinking product is added. In a related embodiment, the dehydrated drinking product is added to a liquid under dynamic motion. Adding the dehydrated drinking product to a dynamic mixing liquid gave superior results. In comparison, adding the liquid last or adding the dehydrated drinking product to a static liquid resulted in the formation of aggregates, which often stick to the sides of the vessel. These aggregates were difficult to dissolve or would not dissolve.

In yet another embodiment, the mixing speed is adjusted to limit the vortex from reaching the stir bar, thereby preventing the mixing of air into the system. Unlike shaking and blending techniques, the introduction of air is avoided using the proper mixing speed. Introduction of air can result in oxidation, acidification and denaturation. When dehydrated drinking products are prepared using the omega prototype at a speed that prevents the vortex from reaching the stir bar, the resultant dehydrated drinking product is free of foam and dissolved gasses, and therefore is greatly improved.

### EXAMPLES OF PREFERRED EMBODIMENTS

The following examples are included to demonstrate preferred embodiments of the invention. It should appreciated by those skilled in the art that the techniques disclosed in the examples that follow represent techniques discovered by the inventors to constitute preferred modes of practice. However, those skilled in the art should, in light of the present disclosure, appreciate that many changes can be made in the specific embodiments which are disclosed and still obtain a like or similar result without departing from the scope of the invention.

### Example 1

An integrated dehydrated drinking product preparation apparatus was constructed comprising of a magnetic stir plate, optimized integrated stir bar, a vessel and cap. The following adaptations were incorporated into the components thereby improving their function and creating a fully integrated system. The novel stir plate modifications include: a positioning element with four raised edges centered every 90 degree along the outer circumference of the mixer, a linear speed control interface comprising of a knob attached to a potentiometer with 270 degrees of rotation and speed control ranging from zero rpms to as much as 1600 rpms, two coupling magnets attached to an iron bar and oriented to optimize field overlap with a specific stir bar, a DC power jack, an AC to DC power transformer, an integrated speed sensing system, an integrated speed maintaining system, a magnetic Hall sensor, an integrated decoupling sensing system, an integrated decoupling recovery system, a microcontroller, a control program and a LED lamp. Stir bar specification include: a roughly cylindrical cross section with dimensions of about 2 inches in length and about ⅜ inch in diameter, a magnetic center with optimal magnetic field overlap of the coupling magnets and encapsulated with PTFE. The novel vessel modifications include: an optimal liquid volume capacity between 4 and 32 ounces, an opening greater than 2 inches in diameter, a slightly convex and smooth interior bottom, a stir bar capturing feature comprising of an increased diameter that creates a cross sectional curvature near the bottom, leak proof threads that integrate with the cap, headspace, a bottom outer diameter slightly less than the diameter of the positioning element, and rough dimensions wherein the height is twice the diameter. The novel cap modifications include: a leak proof threads that make a seal with the vessel, a drinking access port with a leak proof seal and a multi-pronged stir bar retention feature. The integrated dehydrated drinking product preparation apparatus was used to successfully prepare many different dehydrated drinking products for human consumption ranging in volumes from 4 liquid ounces to 32 liquid ounces.

### Example 2

The apparatus described in example 1 was used to prepare 32 ounces of baby formula. The stir plate was plugged in to the power source with the linear speed control interface adjusted to zero rpms. The vessel was filled with 32 ounces of potable water. The stir bar was added to the vessel and the vessel was place on the stir plate and fitted into the positioning element. The addition of the water and stir bar to the vessel and placing the vessel onto the stir plate could be done in any order as long as they were all done before adjusting the speed of the stir plate to greater than zero. Next, the linear control interface was rotated 135 degrees to roughly half speed of about 800 rpms, thereby creating a vortex within the mixing vessel. Powdered baby formula was added to the dynamically mixing system. The system was allowed to mix for 2 minutes. The linear speed interface was adjusted to reduce the speed of the stir plate to zero rpm. The vessel was removed from the stir plate and the cap was placed onto the vessel. The vessel, cap and reconstituted baby formula was stored under refrigeration. When needed, the formula was poured from the vessel through the cap's drinking port into a baby bottle.

### Example 3

The apparatus described in example 1 was used to prepare 16 ounces of GNC's weight gainer 1800 protein drink. The stir plate was plugged in to the power source with the linear speed control interface adjusted to zero rpms. The vessel was filled with 16 ounces of potable water. The stir bar was added to the vessel and the vessel was place on the stir plate and fitted into the positioning element. The addition of the water and stir bar to the vessel and placing the vessel onto the stir plate could be done in any order as long as they were all done before adjusting the speed of the stir plate to greater than zero. Next, the linear control interface was rotated 135 degrees to roughly half speed of about 800 rpms, thereby creating a vortex within the mixing vessel. Dehydrated protein drink was added to the dynamically mixing system. The integrated speed control sensing system and integrated speed control maintaining system adjusted the electrical current to the motor to maintain the speed at 800 rpms. Next the linear speed control interface was readjusted to full speed of about 1600 rpms. The system was allowed to mix for 10 minutes, after which the system automatically stopped mixing. The vessel was removed from the stir plate and the cap was placed onto the vessel. The reconstituted protein drink was consumed directly from the vessel through the cap's drinking port.

### Example 4

Example 3 was repeated up through the point of readjusting the speed to 1600 rpm. After 2 minutes, the vessel was removed from the stir plate. The speed control sensing system and integrated speed control maintaining system adjusted the electrical current to the motor to maintain the speed at 1600 rpms thereby preventing over run due to the sudden decrease in load upon the motor.

### Example 5

The apparatus described in example 1 was used to prepare 24 ounces of Kool Aid. The stir plate was plugged in to the power source with the linear speed control interface adjusted to zero rpms. The vessel was filled with 24 ounces of potable water. The stir bar was added to the vessel and the vessel was place on the stir plate and fitted into the positioning element. The addition of the water and stir bar to the vessel and placing the vessel onto the stir plate could be done in any order as long as they were all done before adjusting the speed of the stir plate to greater than zero. Next, the linear control interface was rotated 135 degrees to roughly half speed of about 800 rpms, thereby creating a vortex within the mixing vessel. An entire cup of Kool Aid with sugar already added was placed in the dynamic mixing system all at once. The contact of the sugar with the stir bar caused the stir bar to decouple from the coupling magnets. The integrated decoupling sensing system detected the decoupling and the integrated decoupling recovery system automatically reduced the motor speed to zero and then returned the mixing speed to 800 rpms once the stir bar and coupling magnets were recoupled. The system was allowed to mix for an additional 5 minutes. The linear speed interface was adjusted to reduce the speed of the stir plate to zero rpm. The vessel was removed from the stir plate and the cap was placed onto the vessel. The reconstituted Kool Aid was poured through the drinking port into serving glasses and consumed.

### Example 6

The apparatus described in example 1 was programmed with control code that allowed speed control from zero rpm to a maximum speed ranging from 800 rpm to 1600 rpm. At first the apparatus was programmed for a maximum speed of 800 rpm. This product program configuration was ideal for preparing low viscous solutions such as iced tea or low volumes of less than 12 ounces. The relatively slow maximum speed prevented possible introduction of air due to over mixing. The same apparatus was reprogrammed with a new maximum speed of 1000 rpms. This second product program configuration was ideal for medium viscosity solution of all volumes such as baby formula. Finally, the apparatus was reprogrammed with a new maximum speed of 1600 rpms. This third product program configuration was ideal for high viscosity solution of large volumes such as 32 ounces of protein supplement drinks. By programming specific maximum speeds between 800 rpm and 1600 rpm, a single design could be used to make different products, each optimized for a specific method.

What is claimed is:

1. An integrated dehydrated drinking product preparation apparatus comprising:
a) a magnetic stir plate further comprising DC electronics, DC power jack, a vessel positioning element with four raised edges positioned every 90 degrees along the outer circumference of the mixer, a linear speed control interface, integrated speed sensing system, speed control from zero rpm to a maximum speed. ranging from 800rpm to 1600 rpm, 2 coupling magnets attached to an iron bar oriented to optimize overlap with the magnetic field of a specific stir bar, a microcontroller, integrated speed sensing system, an integrated speed maintaining system and a LED lamp;
b) an integrated optimized magnetic stir bar further comprising dimensions about 2 inches in length and about ⅜ inch in diameter with optimized magnetic field overlap with the magnetic field of the stir plate's coupling magnets, a roughly cylindrical cross section, and encapsulated with PTFE;
c) a vessel further comprising capacity to hold 4 liquid ounces to about 32 liquid ounces, an opening of greater than 2 inches in diameter, headspace, a matching footprint to fit within the positioning element of the magnetic stir plate, a slightly convex and smooth interior bottom, a stir bar capturing feature with an increased diameter that creates a cross sectional curvature near the bottom, rough dimensions wherein the height is about twice the width and leak proof threads that integrate with the cap;
d) a cap further comprising leak proof threads and seal with the vessel, a drinking access port and cap with leak proof seal and a multi-prong stir bar retention feature.

2. The apparatus of claim 1 further comprising a wall mounted AC to DC transformer.

3. The apparatus of claim 1 with a linear speed control interface further comprising a knob and potentiometer with 270 degrees of rotation.

4. The apparatus of claim 1 further comprising an integrated decoupling sensing system and an integrated decoupling recovery system.

5. The apparatus of claim 1 further comprising a preprogrammed microcontroller with control code optimized for a specific mixing application.

6. The apparatus of claim 1 with an integrated speed sensing system further comprising a magnetic Hall sensor.

7. The apparatus of claim 1 further comprising an automatic time out feature.

8. A method of preparing dehydrated drinking products into liquid consumables using the apparatus of claim 1.

9. A method of claim 8 wherein the liquid is under dynamic motion upon addition of the dehydrated drinking product.

10. A method of claims 8 wherein the mixing speed of the stir plate is adjusted to limit the introduction of air by preventing the vortex from reaching the stir bar.

11. A method of claim 8 further comprising
a) adding the desired amount of liquid to the vessel, adding the stir bar to the vessel and placing the vessel onto the stir plate in any order followed by:
b) adjusting the mixing speed from zero rpms to the desired speed to create a vortex
c) adding the dehydrated drinking product
d) mixing the dehydrated drinking product into a homogeneous liquid mixture.

12. A method of claim 11 wherein the dehydrated drinking product is baby formula.

13. A method of claim 11 wherein the dehydrated drinking product is a protein or amino acid based dietary supplement.

14. A method of claim 8 further comprising of sensing the speed of the magnetic stir plate.

15. A method of claim 8 further comprising of maintaining a mixing speed under increased mechanical load.

16. A method of claim 8 further comprising of maintaining a mixing speed under decreased mechanical load.

17. A method of claim 8 further comprising of sensing decoupling of the coupling magnets and optimized integrated stir bar.

18. A method of claim 8 further comprising of recoupling the coupling magnets and integrated optimized stir bar after decoupling.

19. An apparatus of claim I further comprising of marked graduations on the vessel indicating liquid volume.

20. An apparatus of claim 1 further comprising of a battery pack.
